(19) United States
(12) Patent Application Publication
(10) Pub. No.: US 2003/0145129 A1
(43) Pub. Date: Jul. 31, 2003

(54) Protocol driver application programming interface for operating systems

(76) Inventor: Dhananjay A. Nagalkar, Randolph, NJ (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/062,863

(22) Filed: Jan. 31, 2002

(51) Int. Cl. G06F 13/10

(52) U.S. Cl. 709/321

(57) ABSTRACT

A method and apparatus is provided in which communication between an application and protocol drivers to transmit data to and from a network interface is performed using a standardized protocol driver application programming interface. The interface includes functions having one or more parameters called from an application to cause the protocol driver to drive a protocol service engine (PSE) coupled to the network interface, the PSE being capable of operating a communication channel between the application and the network interface. The interface also includes messages conveying information from the protocol driver to the application about the operation of the communication channel and the data transmitted therein.

### FIELD OF THE INVENTION

The present invention relates generally to application programming interfaces (APIs). More particularly, the present invention relates to APIs for devices which process low level communication protocol signaling.

### COPYRIGHT NOTICE/PERMISSION

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever. The following notice applies to the software, protocols, and data as described below and in the drawings hereto: Copyright ©2001, Intel Corporation, All Rights Reserved.

### BACKGROUND

Advances in semiconductor technology, together with the commoditization of telephony equipment, has resulted in the merger of computer and telephony components. Increasing numbers of central processing unit (CPU) core and communication protocol driver functions co-exist on the same hardware.

Currently, all protocol drivers are written independently. Typically, there is one implementation of the protocol driver for each protocol device, and each implementation has different functionality as well as a different user interface. Users typically have to port their protocol stack to each of the devices they wish to use, which involves coding and testing every time a device's hardware board is changed. Also at present the implementation of the protocol driver is separate from the operating system. Consequently, although the operating systems are ubiquitously available on many hardware systems, the protocol driver remains a specialized application.

One of the problems posed by the foregoing is that writing protocol drivers requires specialized expertise in both computing and telecommunication technology. Developers possessing this combined expertise are few in number. Moreover, the task itself is complex.

### BRIEF DESCRIPTION OF DRAWINGS

The present invention will be described by way of exemplary embodiments, but not limitations, illustrated in the accompanying drawings in which like references denote similar elements, and in which:

FIG. 1 is a block diagram illustrating one generalized embodiment of the architecture of a communications protocol processing engine in which certain aspects of the invention may be practiced;

FIG. 2 is a block diagram illustrating one generalized embodiment of a protocol driver application programming interface (API) in accordance with one embodiment;

FIG. 3 illustrates a typical scenario in which certain aspects of the illustrated invention shown in FIGS. 1-2 may be practiced in accordance with one embodiment;

FIG. 4 illustrates a typical scenario in which certain other aspects of the illustrated invention shown in FIGS. 1-2 may be practiced in accordance with one embodiment;

FIG. 5 illustrates a typical scenario in which certain other aspects of the illustrated invention shown in FIGS. 1-2 may be practiced in accordance with one embodiment;

FIG. 6 is a state diagram illustrating the states that a typical protocol driver follows when controlled through the API of FIG. 2 in accordance with one embodiment; and

FIG. 7 is a block diagram illustrating the components of a function call or message of the API of FIG. 2 in accordance with one embodiment.

### DETAILED DESCRIPTION OF THE INVENTION

In the following description various aspects of the present invention, a protocol driver application programming interface for an operating system will be described. Specific details will be set forth in order to provide a thorough understanding of the present invention. However, it will be apparent to those skilled in the art that the present invention may be practiced with only some or all of the described aspects of the present invention, and with or without some or all of the specific details. In some instances, well-known features may be omitted or simplified in order not to obscure the present invention.

Parts of the description will be presented using terminology commonly employed by those skilled in the art to convey the substance of their work to others skilled in the art, including terms of operations performed by a computer system or electronic commerce application, and their operations, such as transmitting, receiving, retrieving, determining, generating, protocol, data structure, and the like. As well understood by those skilled in the art, these operations take the form of electrical, magnetic, or optical signals, and the operations involve storing, transferring, combining, and otherwise manipulating the signals through electrical, magnetic or optical components of a system. The term system includes general purpose as well as special purpose arrangements of these components that are standalone, adjunct or embedded.

Various operations will be described as multiple discrete steps performed in turn in a manner that is most helpful in understanding the present invention. However, the order of description should not be construed as to imply that these operations are necessarily performed in the order they are presented, or even order dependent. Lastly, repeated usage of the phrase “in one embodiment” does not necessarily refer to the same embodiment, although it may.

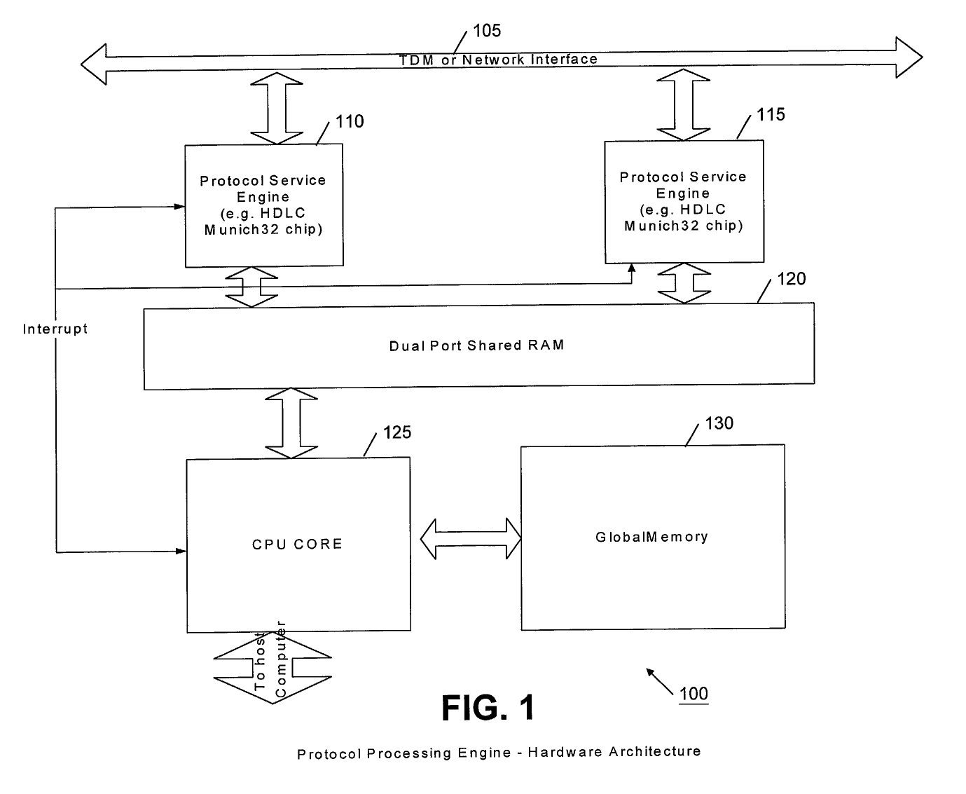

FIG. 1 is a block diagram illustrating one generalized embodiment of the architecture of a communications protocol processing engine in which certain aspects of the invention may be practiced. In the illustrated embodiment, the protocol service engines (PSE) 110/115 are generic HDLC (High-level Data Link Control) devices. HDLC is a group of protocols or rules for transmitting data between network points (sometimes called nodes). HDLC devices are communication devices that are enabled with the HDLC protocols so that they can process low-level communications protocol signaling. It should be appreciated by one of ordinary skill in the art that the PSE 110/115 may also be enabled with other communication protocols besides HDLC, such as ISDN or SS7 Wireless (V5.2), without departing from the scope of the invention.

The network interface 105 (e.g. a TDM (time-division multiplexed) data stream) provides the input digital stream of data messages to the PSEs 110/115. The PSEs 110/115 perform the physical layer (layer-1 of the OSI model) functionality of the communication protocol, and provides the data messages in the form of frames to the CPU core 125. When receiving data the PSE 110/115 checks to make sure that the frames of data are received correctly. If so, the PSE 110/115 further stores the frames in the shared RAM (random access memory) 120, and generates an interrupt 135 to the CPU core 125 to request the processing of the data. The CPU core 125 uses the global memory 130 to process the request. When transmitting data to the network interface 105, the CPU core 125 places the data to be transmitted in the shared RQM 120 and generates another interrupt 105 to trigger the PSE 110/115 to process the outbound data.

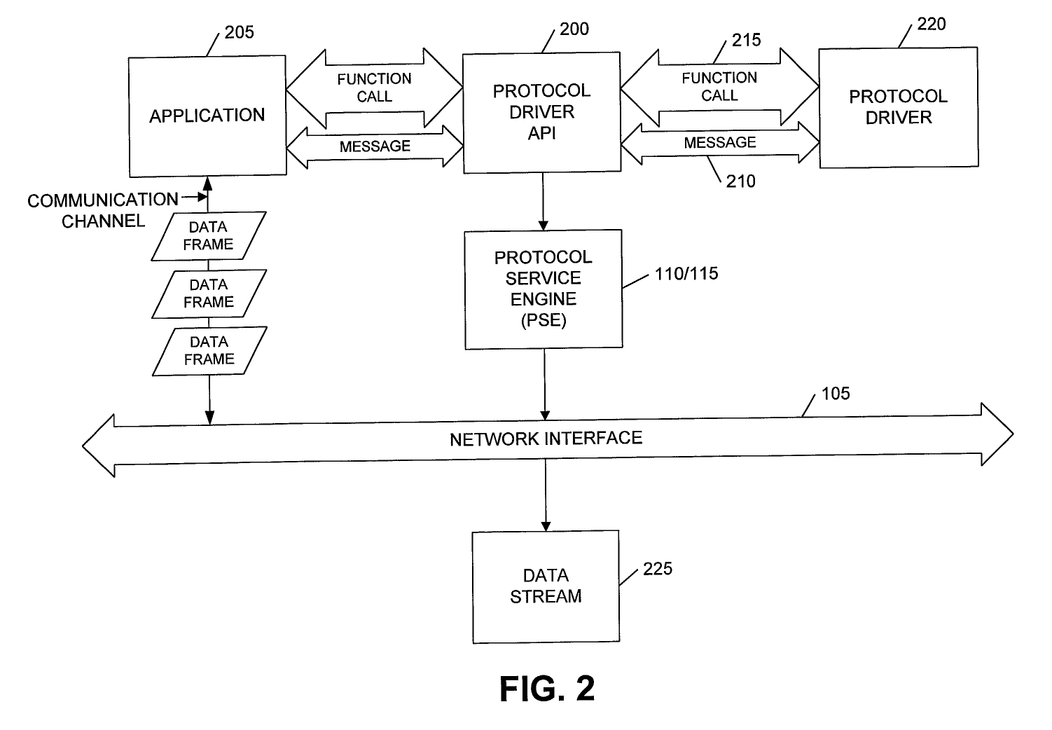

FIG. 2 is a block diagram illustrating one generalized embodiment of a protocol driver application programming interface (API) in accordance with one embodiment. The logic to initialize, configure, control and operate the PSE 110/115 is contained the protocol driver 220. The interface with which an application 205 accesses the protocol driver 220 is the protocol driver API 200. The protocol driver API 200 includes function calls 215 and messages 210. The function calls 215 are used to convey the application's 205 intention to perform certain actions described in more detail below. The messages 210 are used to convey the results of such actions, whether they are triggered by the function calls 215 or by the data 225 received by the protocol driver 220 via the network interface 105.

It should be noted that the illustration in FIG. 2 does not imply that any of the above-described components are located on a single computer system. In fact, the protocol driver 220 might well be disposed within an embedded system on a different computer system than the application 205 in a distributed system architecture environment. The same is true of the protocol driver API 200, the function calls 215 and messages 210 of which may be located on the same or different computer systems, as long as the protocol driver API 200 is accessible to both the application 205 and the protocol driver 220 over a connection such as an inter-process communication (IPC), a transmission control protocol (TCP) connection, or other combination of connections that provide the necessary access.

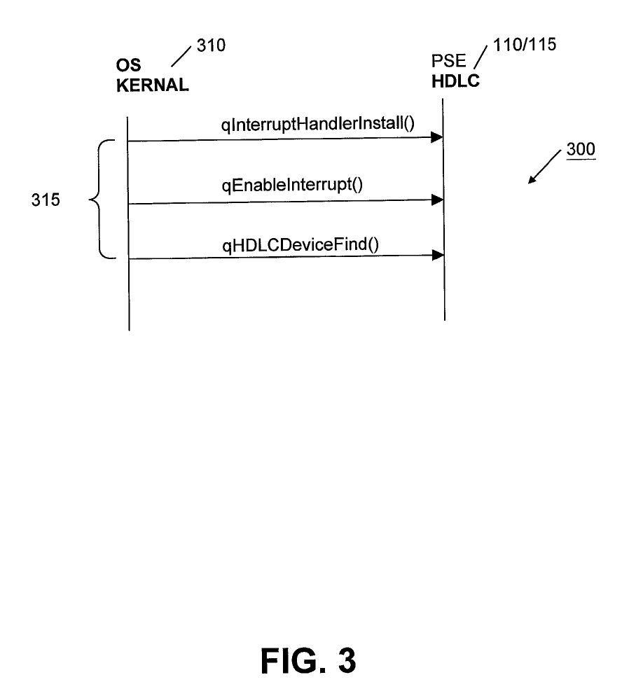

FIG. 3 illustrates a typical scenario 300 in which certain aspects of the illustrated invention shown in FIGS. 1-2 may be practiced in accordance with one embodiment. The operating system kernal 310 uses a series of function calls 215/315 to install the protocol driver API 200 on the operating system and hardware, in this case an HDLC device incorporating the protocol service engine (PSE) 110/115. In the illustrated embodiment the function calls 215/315 comprise a qInterruptHandlerInstall( ) and qEnableInterrupt( ) function call to set up the messaging and interrupt-handling interface. The qHDLCDeviceFind function call operates to query the computer system's 100 hardware to discover the devices that can support the protocol driver 220. It is understood by one of ordinary skill in the art that other types of function calls 315 to install the protocol driver API 200 may be used without departing from the scope of the invention.

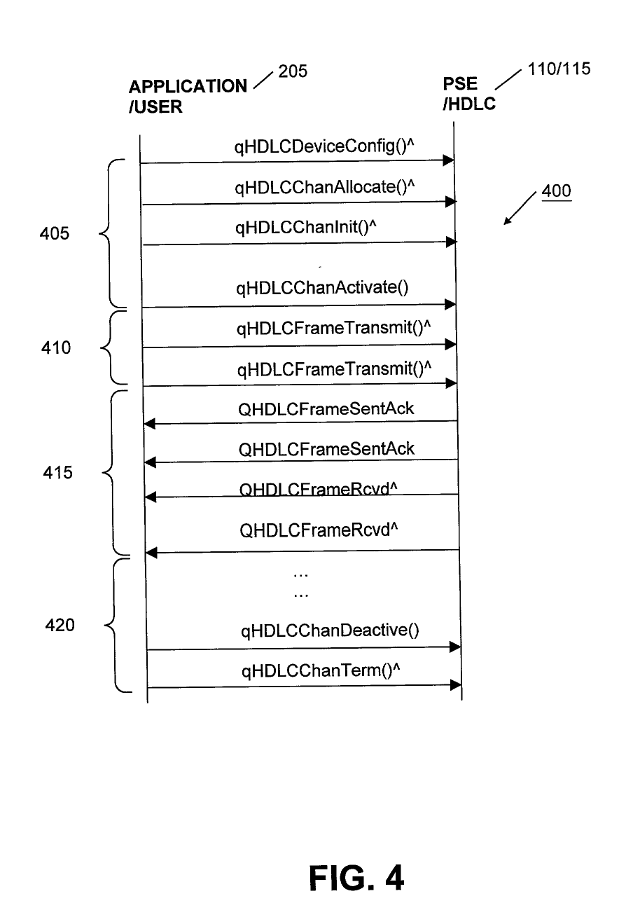

FIG. 4 illustrates a typical scenario 400 in which certain other aspects of the illustrated invention shown in FIGS. 1-2 may be practiced in accordance with one embodiment. Now that the protocol driver API 200 is installed, the application/user 205 communicates via the protocol driver API 200 and protocol driver 220 with the PSE/HDLC device 110/115 using a series of function calls 405 to configure the PSE/HDLC device 110/115 and to allocate, initialize, and activate a communications channel to the PSE/HDLC device 110/115. After the communications channel is activated, the exhange of frames of data between the application/user 205 and the network interface 105 side of the PSE/HDLC 110/115 protocol is accomplished using a series of function calls 410 to transmit the frames, and a corresponding series of messages 415 to acknowledge that the frames were received. Upon termination of the communication, the communication channel is deactivated and terminated using function calls 420.

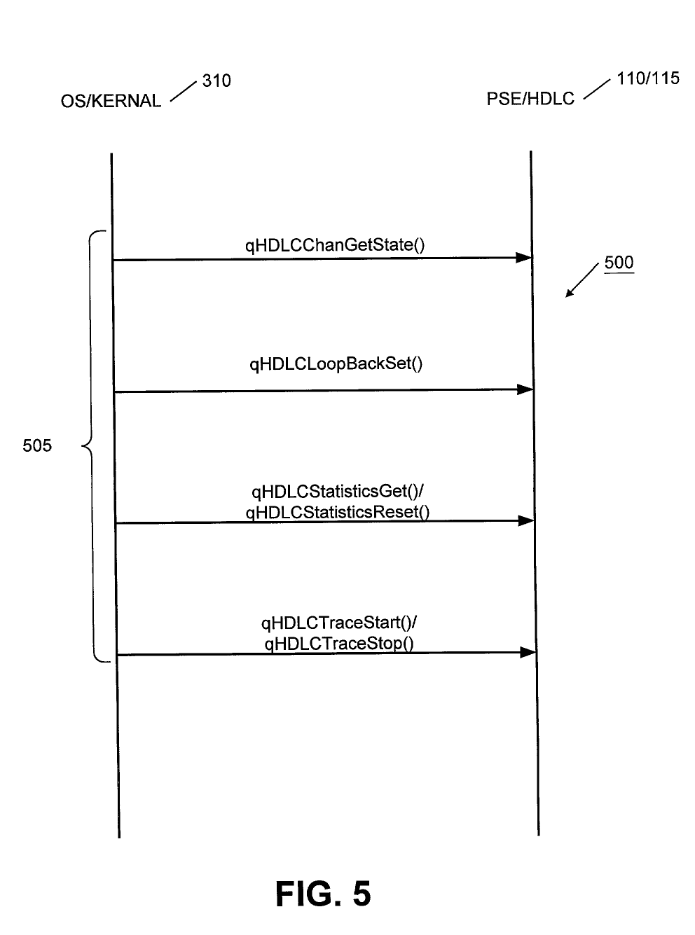

FIG. 5 illustrates a typical scenario 500 in which certain other aspects of the illustrated invention shown in FIGS. 1-2 may be practiced in accordance with one embodiment. During the time that a communications channel is activated, additional function calls 505 may be used to perform systems tests and maintenance on the active channels. In particular, the operating system kernal 310 uses a series of function calls 505 to obtain statistics and other information about the channel. In the illustrated embodiment the function calls 505 comprise a qHDLCGetChanState( ) function call which returns the state of a channel, a qHDLCLoopbackSet( ), which performs a loop-back test on a channel, a qHDLCStatiticsGet( ) and qHDLCStatiticsReset( ), which gets statistical data on the activities of the channel, and a qHDLCTraceStart( )/qHDLCTraceStop( ), which traces activities on a channel, and which is useful to trace the protocol. It is understood by one of ordinary skill in the art that other types of function calls 505 to to perform systems tests and maintenance on the active channels may be used without departing from the scope of the invention.

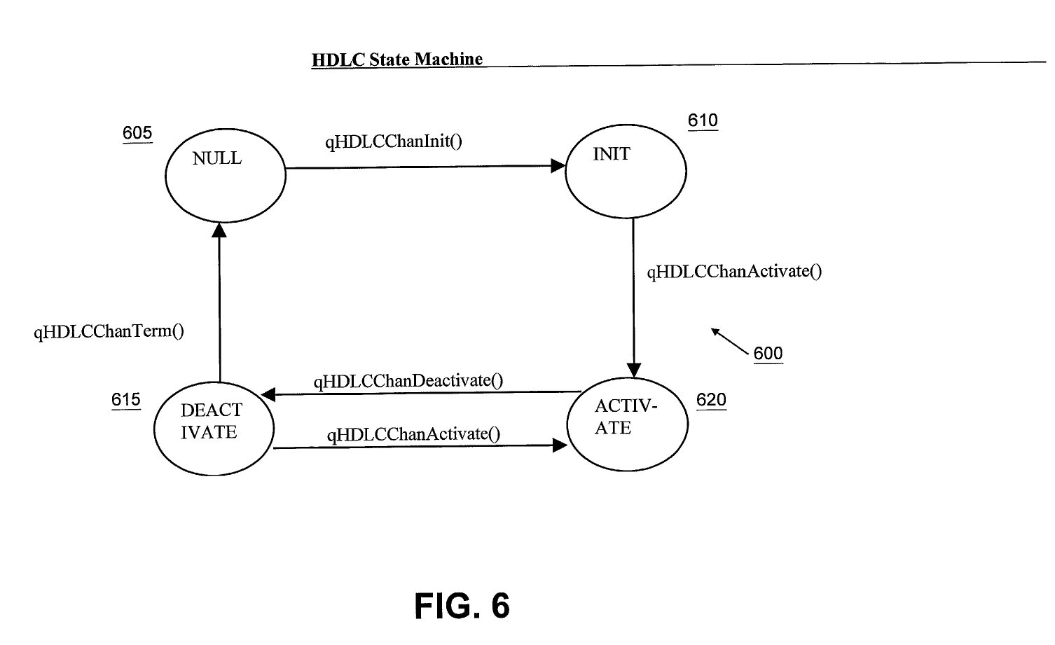

FIG. 6 is a state diagram illustrating some of the states that a typical protocol driver on a PSE/HDLC 110/115 follows when controlled through the protocol driver API 200 of FIG. 2 in accordance with one embodiment. As shown the PSE/HDLC 110/115 has a null state 605, an init sate 610, a deactivate state 615, and an activate state 620, each of which are the result of one or more of the function calls 215/315/405-420/505 performed as illustrated and described in the scenarios in FIGS. 3-5. In the illustrated example, the states are the result of a communications channel being initialized, activated, deactivated, and terminated using the a series of function calls 405 and 420 illustrated in FIG. 4.

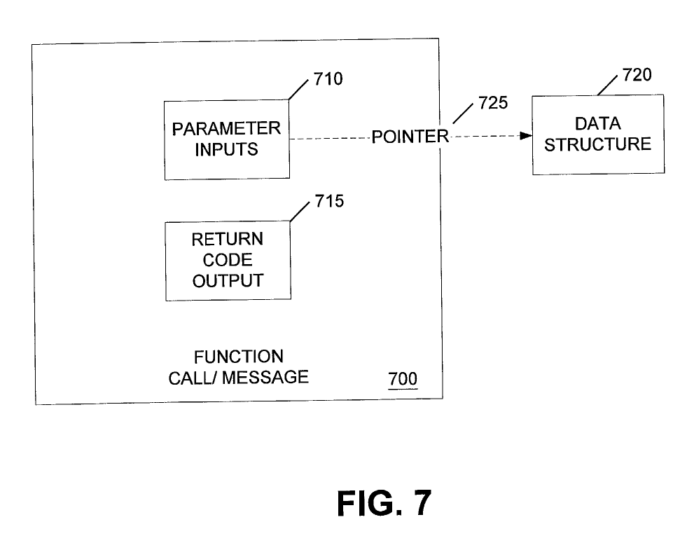

FIG. 7 is a block diagram that illustrates the components of a function call (or message) 700 that comprises the protocol driver API 200 in accordance with an embodiment of the invention. The function call 700 invokes the logic that processes the identified function (or message) and may include one or more parameter inputs 710, and at least one return code output 715. The return code output is a value that indicates the successful completion of the function call or message 700, or in the case of the function call, alternatively contains a value of one or more error codes that indicate one or more reasons why the function call failed. In one embodiment, the parameter inputs 710 are pointers 725 to one or more data structures 720 that contain the various channel identification, configuration, attribute, status, or other data used to initialize and maintain the operation of the channels using the protocol driver API 200.

Table 1 summarizes examples of the various function calls 700 that may be defined in the protocol driver API 200. It should be noted that in the summary table and descriptions that follow, the actual identification of the function, message, parameter inputs and return code outputs are used for convenience only, and other identification may be used to describe the function, message, parameter inputs and return code outputs without departing from the scope of the invention. In particular, while the functions, messages, parameter inputs and return code outputs are described in relation to the HDLC communication protocol, they may also be used with other PSEs for other communication protocols, such as IDSN or SS7 Wireless (V5.2), without departing from the scope of the invention. Moreover, the examples summarized in Table 1 do not exhaust the list of function calls or messages that may be invoked in accordance with an embodiment of the invention.

TABLE 1
Function Calls

| API Function Name | Description |
|---|---|
| qHDLCChanActivate( ) | Attempts to put a channel in service |
| qHDLCChanAllocate( ) | Allocates a channel based on an attribute |
| | list |
| qHDLCChanDeactivate( ) | Takes a channel out of service |
| qHDLCChanFree( ) | Frees a channel and its associated timeslots |
| qHDLCChanInit( ) | Configures and initializes a channel |
| qHDLCChanStateGet( ) | Returns the current state of a channel |
| qHDLCChanTerm( ) | Deletes a channel and frees resources |
| qHDLCDeviceConfig( ) | Configures an HDLC device |
| qHDLCDeviceFind( ) | Finds an HDLC device with the specified |
| | attributes |
| qHDLCFrameTransmit( ) | Sends a frame on the specified channel |
| qHDLCLoopBackSet( ) | Puts an HDLC device in a loopback mode |
| qHDLCRcvDisable( ) | Disables inbound frame processing on a |
| | channel |
| qHDLCRcvEnable( ) | Enables inbound frame processing on a |
| | channel |
| qHDLCReset( ) | Initializes all HDLC channels and |
| | associated timeslots |
| qHDLCStatisticsGet( ) | Retrieves statistics counter values for a |
| | channel |
| qHDLCStatisticsReset( ) | Resets all statistic counter values for a |
| | channel |
| qHDLCTraceStart( ) | Starts a debug trace on a channel |
| qHDLCTraceStop( ) | Stops the debug trace on a channel |
| qHDLCXmtDisable( ) | Disables outbound frame transmission on a |
| | channel |
| qHDLCXmtEnable( ) | Enable outbound frame transmission on a |
| | channel |

The qHDLCChanActivate( ) function attempts to put a channel in service by enabling the transmission and reception of frames on the channel. The state of the channel is set to ACTIVE (see FIG. 6 for a description for the possible states of a channel). The function returns an error if the specified channel is not configured and initialized. The parameters include pchanHandle, a pointer to a data structure that identifies the HDLC channel, and Timeout, a timeout value (in milliseconds) to wait for the function to return.

The qHDLCChanAllocate( ) function call allocates a channel based on an attribute list provided by a user. The attribute list is located in the data structure pointed to by the parameter pChanAttributes. The attributes are compared with the attributes of the HDLC devices on the board. If a match is found, the channel is allocated and all corresponding timeslots are marked as used. All the timeslots to be associated with the channel must be on the same device. If all the specified attributes are set to ANY, then the first available channel is allocated.

The qHDLCChanDeactivate( ) function call takes a channel out of service by suspending the transmission and reception of frames. The channel state is set to DEACTIVATED (see FIG. 6 for a description for the possible states of a channel). The channel must be reactivated (using the qHDLCChanActivate( ) function call) in order to resume transmission and reception of frames. When the channel is reactivated, the transmit and receive queues are reinitialized, and therefore any remaining data in the queues is cleared.

The qHDLCChanFree( ) function call frees a channel and its associated timeslot(s). The specified HDLC channel and the timeslots allocated to that channel are returned to the free pool.

The qHDLCChanInit( ) function configures and initializes a channel with the settings pre-configured in the data structure pointed to by the parameter pConfig_Blk. The channel state is set to INIT (see FIG. 6 for a description for the possible states of a channel), and sufficient memory is allocated for the transmission and reception of frames. The specified channel is then initialized with the settings in the pre-configured data structure.

The qHDLCChanStateGet( ) function call returns the current channel state, the state provided in the data structure pointed to by the pState parameter.

The qHDLCChanTerm( ) function immediately deletes a channel and frees the resources. The channel state is set to NULL. (see FIG. 6 for a description for the possible states of a channel). All resources allocated to a channel are freed and the channel can again be configured using the qHDLCChanInit( ) function call.

The qHDLCDeviceConfig( ) function call configures a device using device settings pre-configured in the data structure pointed to by the parameter pConfig_Blk. The device settings can be initialized to default values by setting the values in the data structure to DEFAULT, but the user has the option to change any of the values. This function also allocates memory for, and initializes the device's interrupt queue.

The qHDLCDeviceFind( ) function finds an HDLC device based on an attribute list provided by a user. The attributes that the user wants the HDLC device to possess are located in the data structure pointed to by the parameter pHDLCAttributes. The attributes are compared to the attributes of the available HDLC devices. If a match is found, this function call provides a pointer to the identity of the HDLC device that matches the required attributes. This function also indicates if the device found is available. If all attributes are set to a value of ANY, then all available HDLC devices are identified. If no device with the specified attributes is found, the a noOfDevices field in the data structure pointed to by parameter pDeviceInfo will contain the value zero.

The qHDLCFrameTransmit( ) function sends a frame of data over a channel. The frame is sent to an HDLC transmit queue for the channel, where it is queued for transmission.

The qHDLCLoopBackSet( ) function sets the loopback configuration based on a loopback type in the loopback parameter. There are two basic types of loopbacks (external and internal) that can be run on one channel or all channels. The external loopback routes receive data for a T-1/E-1 or SCbus timeslot to the transmit data for the same timeslot. The internal loopback routes transmit data for an channel (using the qHDLCFrameTransmit( ) function call) to receive data for that channel.

The qHDLCRcvDisable( ) function call disables inbound frame processing on a channel. The qHDLCRcvEnable( ) function enables inbound frame processing on a channel.

The qHDLCReset( ) function initializes all channels and associated timeslots. All channels are set to the NULL state (see FIG. 6 for a description for the possible states of a channel). The transmit and receive queues are initialized and the device starts transmitting flags or an idle pattern depending on the configuration. This affects only those channels that are configured for transmission or reception.

The qHDLCStatisticsGet( ) function retrieves statistic counter values for a channel and returns in the parameter pStatistics a pointer to a data structure containing those values. A reset parameter indicates if the statistics counters must be reset after being retrieved. The qHDLCStatisticsReset( ) function call resets all statistic counter values for a channel, then resumes the collection of statistic values.

The qHDLCTraceStart( ) function starts a debug trace on a channel. The user specifies information about the buffer that will be used to store trace data. The user also specifies a component ID if a DM3 component is requesting the trace. The buffer information includes the starting address of the buffer, the size of the buffer, and the number of blocks into which the buffer will be divided. Each time a buffer block is filled, a qHDLCTraceBlkFilled notification message is sent to the calling task. On receiving a qHDLCTraceBlkFilled notification message, the calling task must copy the trace information from the buffer block or risk the trace data being overwritten if the buffer fills and older trace data is overwritten by newer trace data. The calling task may send the completed trace history to the host for later assembly and post-processing.

The qHDLCTraceStop( ) function stops a debug trace on a channel. A QHDLCTraceBlkFilled message is sent to the calling task indicating if there is any remaining data in a trace buffer block.

The qHDLCXmtDisable( ) function disables outbound frame transmission on a channel, and the qHDLCXmtEnable( ) function enables outbound frame transmission on a channel.

Table 2 summarizes examples of the various messages 700 that may be defined in the protocol driver API 200. It should be noted that in the summary table and descriptions that follow, the actual identification of the message is used for convenience only, and other identification may be used to describe the message without departing from the scope of the invention. In particular, while the messages are described in relation to the HDLC communication protocol, they may also be used with other PSEs for other communication protocols, such as IDSN or SS7 Wireless (V5.2), without departing from the scope of the invention. Moreover, the examples summarized in Table 2 do not exhaust the list of messages that may be generated in accordance with an embodiment of the invention.

TABLE 2
Messages

| API Message Name | Description |
|---|---|
| QHDLCFrameSentAck | Reply message indicating that a frame has |
| | been successfully sent from the device to |
| | the underlying physical media using |
| | qHDLCFrameTransmit( ) function call |
| qHDLCErrorStatus | Reply message indicating that an error |
| | occurred in the FIDLC transmit or receive |
| | tasks |
| qHDLCFrameRcvd | Reply message indicating that a frame has |
| | been successfully received from the |
| | underlying physical media on the specified |
| | HDLC channel |
| QHDLCTraceBlkFilled | A status message sent when the HDLC |
| | frame tracing feature in enabled using the |
| | qHDLCTraceStart( ) function call and a |
| | buffer block in the trace buffer has been |
| | filled, or when the user disables the trace |
| | for the specified channel using |
| | qHDLCTraceStop( ) function call. |

It is to be appreciated that the function calls 215/315/405-420/505, messages 210 and other actions to be performed by a computer system 100 executing the protocol driver API 200 may constitute computer programs made up of computer-executable instructions. In one embodiment, the protocol driver API 200 might be implemented in an embedded system that is separate from the PSEs 110/115 and protocol drivers, or separate from the application, as in a distributed architecture system. The above-described scenarios and state diagrams enables one skilled in the art to develop such programs including such instructions to carry out the function calls, messages and other actions of the protocol driver API 200 on suitably configured computers (the processor of the computer executing the instructions from computer-accessible media). The computer-executable instructions may be written in a computer programming language or may be embodied in firmware logic, or in micro-engine code, or the like. If written in a programming language conforming to a recognized standard, such instructions can be executed on a variety of hardware platforms and for interface to a variety of operating systems. In addition, the present invention is not described with reference to any particular programming language. It will be appreciated that a variety of programming languages may be used to implement the teachings of the invention as described herein. Furthermore, it is common in the art to speak of software, in one form or another (e.g., program, procedure, process, application . . . ), as taking an action or causing a result. Such expressions are merely a shorthand way of saying that execution of the software by a computer causes the processor of the computer to perform an action or a produce a result.

Accordingly, a novel method is described for a protocol driver application programming interface for an operating system. From the foregoing description, those skilled in the art will recognize that many other variations of the present invention are possible. Thus, the present invention is not limited by the details described. Instead, the present invention can be practiced with modifications and alterations within the spirit and scope of the appended claims.

I claim:

1. A method of communication between an application and a protocol driver to facilitate the transmission of data to a network interface comprising:
calling a function having a parameter from an application to cause a protocol driver to drive a protocol service engine (PSE) coupled to a network interface, the PSE being capable of operating a communication channel for transmitting a data between the application and the network interface; and
sending a message from the protocol driver to the application conveying a result triggered by calling the function.

2. The method of claim 1, wherein the result conveyed in the message is about the data transmitted between the application and the network interface.

3. The method of claim 1, further comprising calling the function from an operating system kernal to cause the protocol driver to drive the PSE to discover a device that is supported by the protocol driver and, if discovered, again calling the function to initialize a messaging and an interrupt-handling interface between the device and the operating system kernal.

4. The method of claim 3, further comprising calling the function from the operating system kernal to cause the protocol driver to drive the PSE to configure the device according to the function's parameter value.

5. The method of claim 1, wherein calling the function from the application causes the protocol driver to drive the PSE to initiate the communication channel according to the function's parameter value.

6. The method of claim 1, wherein calling the function from the application causes the protocol driver to drive the PSE to allocate a bandwidth for the communication channel according to the function's parameter value.

7. The method of claim 1, wherein calling the function from the application causes the protocol driver to drive the PSE to terminate the communication channel according to the function's parameter value.

8. The method of claim 1, wherein calling the function from the application causes the protocol driver to drive the PSE to activate the communication channel according to the function's parameter value.

9. The method of claim 1, wherein calling the function from the application causes the protocol driver to drive the PSE to transmit a data frame across the communication channel according to function's parameter value.

10. A method of operating a protocol service engine (PSE), the PSE having a standard interface comprising a function having at least one parameter, the parameter containing a pointer to a data structure associated with the function, wherein invoking the function controls the PSE to process a data stream over a channel between an application and a network.

11. The method of claim 10 wherein the function comprises one of:
identifying a device associated with the PSE having at least one device attribute as specified in the data structure;
configuring the identified device based on a device configuration as specified in the data structure;
allocating the channel on the identified device and at least one timeslot on the channel based on at least one channel attribute as specified in the data structure;
initializing the channel based on a channel configuration as specified in the data structure; and
setting a loopback configuration on the channel based on a loopback type specified in the data structure.

12. The method of claim 11, wherein the function further comprises one of:
activating the channel to transmit and receive the data stream; and
transmitting a frame of the data stream to a transmit queue for the channel.

13. The method of claim 11, wherein the function further comprises one of:
deactivating the channel to suspend transmitting and receiving the data stream; and
terminating the channel to free the channel and the at least one timeslot.

14. The method of claim 11, wherein the function further comprises one of:
returning a state of the channel, the state being placed in the data structure;
resetting the state of the channel to null;
retrieving a statistics counter value of the channel, the statistics counter value being placed in the data structure;
resetting the statistics counter value of the channel;
starting a trace on the channel, a result of the trace being placed in a trace buffer as specified in the data structure; and
stopping the trace on the channel.

15. The method of claim 11, wherein the function further comprises one of:
disabling an inbound data stream on the channel;
enabling the inbound data stream on the channel;
disabling an outbound data stream on the channel; and
enabling an outbound data stream on the channel.

16. The method of claim 10, further comprising a message having at least one message parameter, the message parameter containing a pointer to a message data structure associated with the message.

17. The method of claim 16, wherein the message comprises one of:
acknowledging that a frame of the data stream on the channel has been transmitted;
acknowledging that the frame of the data stream on the channel has been received;
indicating that an error has occurred on the channel, the error specified in the message data structure; and
indicating that a trace buffer containing the result of a trace on the channel has been filled.

18. An apparatus to process a data stream on a network comprising:
an application;
a protocol driver;
a protocol service engine (PSE); and
a protocol driver application programming interface (API) coupled to the PSE, wherein the API communicates with the application and the protocol driver using a standard interface to cause the PSE to process a data stream over a channel between the application and a network, the standard interface comprising a function having at least one parameter, the parameter containing a pointer to a data structure associated with the function.

19. The apparatus of claim 18 wherein the function is capable of identifying a device associated with the PSE having at least one device attribute as specified in the data structure.

20. The apparatus of claim 18 wherein the function is capable of configuring a device based on a device configuration as specified in the data structure.

21. The apparatus of claim 18 wherein the function is capable of allocating the channel on a device and at least one timeslot on the channel based on at least one channel attribute as specified in the data structure.

22. The apparatus of claim 18 wherein the function is capable of initializing the channel based on a channel configuration as specified in the data structure.

23. The apparatus of claim 18 wherein the function is capable of setting a loopback configuration on the channel based on a loopback type specified in the data structure.

24. The apparatus of claim 18 wherein the function is capable of activating the channel to transmit and receive the data stream.

25. The apparatus of claim 18 wherein the function is capable of causing the channel to transmit a frame of the data stream to a transmit queue.

26. The apparatus of claim 18 wherein the function is capable of deactivating the channel to suspend transmitting and receiving the data stream.

27. The apparatus of claim 18 wherein the function is capable of terminating the channel to free the channel and to free any timeslot that was allocated for the channel.

28. The apparatus of claim 18 wherein the function is capable of returning a state of the channel, the state being placed in the data structure.

29. The apparatus of claim 18 wherein the function is capable of resetting a state of the channel to null.

30. The apparatus of claim 18 wherein the function is capable of retrieving a statistics counter value of the channel, the statistics counter value being placed in the data structure.

31. The apparatus of claim 18 wherein the function is capable of resetting the statistics counter value of the channel.

32. The apparatus of claim 18 wherein the function is capable of starting a trace on the channel, a result of the trace being placed in a trace buffer as specified in the data structure.

33. The apparatus of claim 18 wherein the function is capable of stopping a trace on the channel.

34. The apparatus of claim 18 wherein the function is capable of disabling an inbound data stream on the channel.

35. The apparatus of claim 18 wherein the function is capable of enabling the inbound data stream on the channel.

36. The apparatus of claim 18 wherein the function is capable of disabling an outbound data stream on the channel.

37. The apparatus of claim 18 wherein the function is capable of enabling an outbound data stream on the channel.

38. The apparatus of claim 18, wherein the standard interface further comprises a message having at least one message parameter, the message parameter containing a pointer to a message data structure associated with the message.

39. The apparatus of claim 38 wherein the message is capable of conveying an acknowledgement that a frame of the data stream on the channel has been transmitted.

40. The apparatus of claim 38 wherein the message is capable of conveying an acknowledgement that a frame of the data stream on the channel has been received.

41. The apparatus of claim 38 wherein the message is capable of conveying an Indication that an error has occurred on the channel, the error specified in the message data structure.

42. The apparatus of claim 38 wherein the message is capable of conveying an indication that a trace buffer containing the result of a trace on the channel has been filled.

43. An article of manufacture comprising a machine-accessible medium including data that, when accessed by a machine, cause the machine to:
generate a function call, the function call having a parameter containing a pointer to a data structure associated with the function call, wherein the function call is capable of causing the protocol driver to drive a protocol service engine (PSE) coupled to a network interface, the PSE being capable of operating a communication channel between an application and the network interface; and
generate a message, the message having a message parameter containing a pointer to a message data structure associated with the message, the message capable of being sent from the protocol driver to the application to convey information regarding the operation of the communication channel.

44. The article of manufacture of claim 43, wherein the generated function call further causes the machine to:
identify a device associated with the PSE having at least one device attribute as specified in the data structure;
configure the identified device based on a device configuration as specified in the data structure;
allocate the channel on the identified device and at least one timeslot on the channel based on at least one channel attribute as specified in the data structure;
initialize the channel based on a channel configuration as specified in the data structure; and
set a loopback configuration on the channel based on a loopback type specified in the data structure.

45. The article of manufacture of claim 43, wherein the generated function call further causes the machine to:
activate the channel to transmit and receive the data stream; and
transmit a frame of the data stream to a transmit queue for the channel.

46. The article of manufacture of claim 43, wherein the generated function call further causes the machine to:
deactivate the channel to suspend transmitting and receiving the data stream; and
terminate the channel to free the channel and the at least one timeslot.

47. The article of manufacture of claim 43, wherein the generated function call further causes the machine to:
return a state of the channel, the state being placed in the data structure;
reset the state of the channel to null;
retrieve a statistics counter value of the channel, the statistics counter value being placed in the data structure;
reset the statistics counter value of the channel;
start a trace on the channel, a result of the trace being placed in a trace buffer as specified in the data structure; and
stop the trace on the channel.

48. The article of manufacture of claim 43, wherein the generated function call further causes the machine to:
disable an inbound data stream on the channel;
enable the inbound data stream on the channel;
disable an outbound data stream on the channel; and
enable an outbound data stream on the channel.

49. The article of manufacture of claim 43, wherein the generated message further causes the machine to convey:
an acknowledgement that a frame of the data stream on the channel has been transmitted;
an acknowledgement that the frame of the data stream on the channel has been received;
an indication that an error has occurred on the channel, the error specified in the message data structure; and
an indication that a trace buffer containing the result of a trace on the channel has been filled.
